(19) United States
(12) Patent Application Publication
(10) Pub. No.: US 2007/0204805 A1
(43) Pub. Date: Sep. 6, 2007

(54) Umbrella and leash

(76) Inventor: Jared Glenn Brody, Hoboken, NJ (US)

Correspondence Address: ELLIOT FURMAN, 15 WEST 81ST STREET #11J, NEW YORK, NY, 10024, US

(21) Appl. No.: 11/368,650

(22) Filed: Mar. 6, 2006

(51) Int. Cl. A01K 27/00

(52) U.S. Cl. 119/796

(57) ABSTRACT

An umbrella and leash apparatus comprises an umbrella, a handle attached to the umbrella, and a leash extending from the handle. The handle comprises a retractable leash assembly mounted within the handle. The leash is connected to the retractable leash assembly. An actuator for extending or retracting the leash is in selective engagement with the retractable leash assembly.

### BACKGROUND

Almost every dog owner has enjoyed a long walk on a sunny day with their beloved pet. Some owners even enjoy walking their animals in the rain. And then there are those times when nature calls—a walk is not optional—the dog must be taken out, rain or shine, day or night.

No matter what the reason for walking the dog, virtually every dog walker has experienced the inconvenience of having to brave inclement weather. During these times, the dog walker usually fumbles between a dog leash, an umbrella, tending to the needs of the dog, and collecting and disposing of waste, all while trying to keep dry. To complicate matters, the walker frequently has to access his or her pockets for keys, gloves, disposable bags, towels, and other items. Dog walkers usually have difficulties deftly handling all of these tasks and, as a result, both the dog and dog walker wind up wet, cold, and unhappy from what should have been a routine dog walk.

It would be desirable to reduce the unnecessary complexity of such a routine and, what should be, enjoyable activity between a dog and his owner. Thus, a need presently exists for a combined umbrella and leash.

### SUMMARY

An umbrella and leash apparatus comprises an umbrella, a handle, and a leash. The umbrella comprises a shaft and a canopy. The shaft has a first end and a second end. The canopy is mounted to the first end of the shaft. The handle is connected to the second end of the shaft. The leash has a first leash end and a free leash end. The first leash end is connected to the handle. The leash comprises a connector connected to the free leash end. In one embodiment, the handle comprises a retractable leash assembly and an opening. The first leash end is connected to the retractable leash assembly and the free leash end extends through the opening. An actuator mounted on the handle is in selective engagement with the retractable leash assembly. In another embodiment, the apparatus comprises a buckle connected between the handle and first leash end of the leash. In one more embodiment, the handle comprises a socket, the first leash end is connected to a ball, and the ball is disposed within the socket. In yet another embodiment, the first leash end is permanently connected to the handle.

The foregoing paragraph has been provided by way of general introduction, and it should not be used to narrow the scope of the following claims. The preferred embodiments will now be described with reference to the attached drawings.

### BRIEF DESCRIPTION OF THE DRAWINGS

FIG. 1 is a side view of an umbrella and leash apparatus with the umbrella in an open position.

FIG. 2 is a side view of an umbrella and leash apparatus with the umbrella in a collapsed and folded position.

FIG. 3 is a side view of an umbrella and leash apparatus with the umbrella separated from the leash, the umbrella in a collapsed and stored position, and the leash partially extended.

FIG. 4 is a side view of a handle and leash having a top handle and a bottom handle.

FIG. 5 is a side view of a handle and leash having a single, non-detachable handle.

FIG. 6 is a side view of an umbrella and leash apparatus with a fixed length, non-retractable leash.

FIG. 7 is a side view of a handle of an umbrella and leash apparatus with the leash attached to the handle by way of a ball-and-socket joint.

### DETAILED DESCRIPTION OF THE PRESENTLY PREFERRED EMBODIMENTS

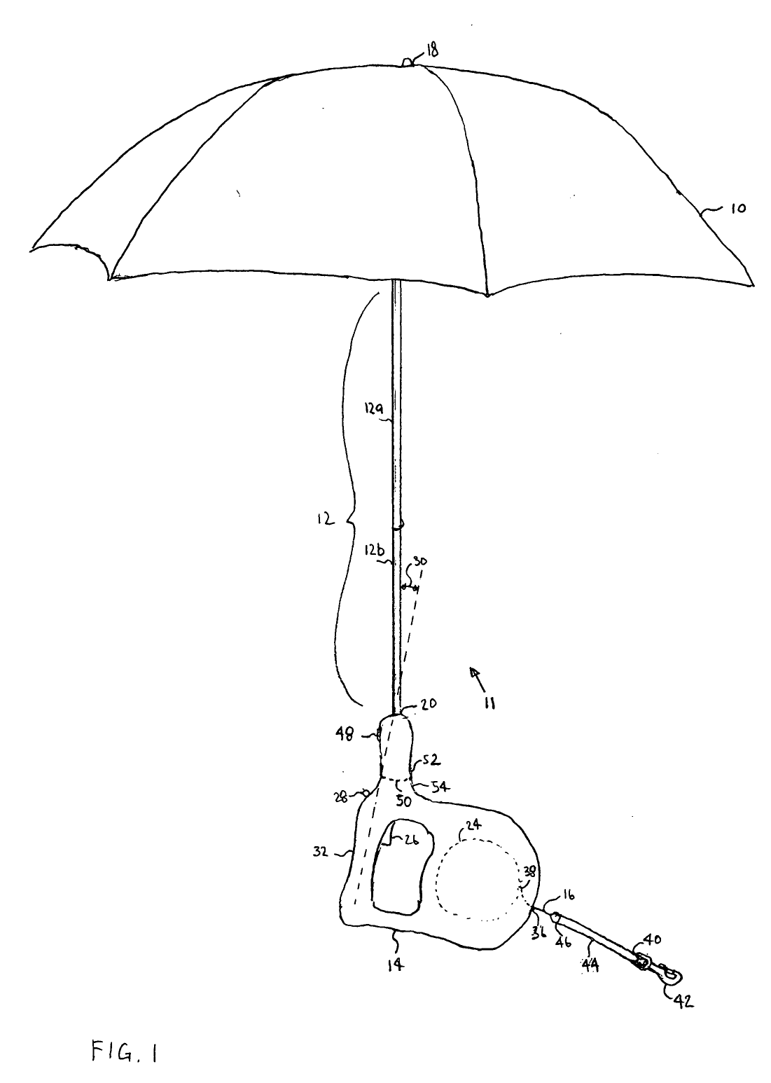

FIG. 1 shows a side view of an umbrella and leash apparatus. The umbrella 11 comprises a canopy 10 and a shaft 12. The shaft 12 has a first end 18 and a second end 20. The canopy 10 is mounted to the first end 18 of the shaft 12. A handle 14 is connected to the second end 20 of the shaft 12. A leash 16 is connected to the handle 14.

A retractable leash assembly 24 is mounted within an interior cavity defined by the handle 14. Actuators 26 and 28 mounted on the handle, and in selective engagement with the retractable leash assembly 24, control the operation of the retractable leash assembly 24. When depressed or moved by a user of the umbrella and leash apparatus, actuators 26 and 28 permit or cause the leash 16 to be extended, retracted, braked, or locked.

Retractable leashes have been around for a very long time and are well understood by those skilled in the art. They are extremely popular with dog owners, and their design has been improved many times since their inception. Almost all retractable leashes work in a similar fashion. The term “retractable leash assembly” is used in the art to describe the mechanism of a retractable leash, whereas the term “retractable leash” includes the retractable leash assembly, the housing in which it is mounted, and the leash.

Briefly, a retractable leash assembly comprises a spring biased spool or reel. At least one of a trigger, button, or a switch is selectively engaged (by a user) with the spool or reel. The term “actuator” is used herein to refer interchangeably to the trigger, button, or switch. The spool is rotatably mounted in a housing and the actuator or actuators are arranged on the housing to allow a user to push, depress, or move the actuator. The housing is usually of an ergonomic design and including a handle and grip, so as to allow a user to securely and comfortably grasp the housing. The housing is usually made of plastic. One end of a leash is connected to the spool and passes through an opening in the housing. The other end of the leash usually comprises a connector such as a swivel-hook.

In use, the swivel-hook is connected to the collar of a dog. The leash extends from the housing as the dog moves away from the handler, who is holding the retractable leash, thereby exerting tension on the leash and causing the spool to rotate and let out the leash. As the animal moves towards the handler the tension decreases and the spring bias on the spool exerts a force on the spool, causing it to rotate in an opposite direction, and retracting the cord, which is wrapped around and stored on the spool interior to the housing. Depending on the specific configuration, when depressed or moved the actuator or actuators engage with the spool to inhibit its rotation, thereby temporarily fixing the length of the leash. Also, depending on the specific configuration, the actuator or actuators may also temporarily lock the spool so the handler does not have to depress the actuator to maintain a temporary fixed length. Also, the actuator may engage a brake mechanism for slowing down the speed of the spool, and thus the speed at which the leash can be extended or retracted.

While the above describes the most pervasive form of a retractable leash assembly, it is understood that other assemblies that are not spool based are possible and that these assemblies may be used with the present invention while remaining within the scope of the present invention.

It is by now apparent to those skilled in the art that any of the conventional and well-known retractable leash assemblies may be used by themselves, or in combination, with the present invention. With this in mind, the following U.S. patents or patent applications are hereby incorporated by reference in their entireties: U.S. Pat. Nos. 2,217,323; 2,222,409; 2,250,171; 2,314,504; 2,919,676; 3,233,591; 3,693,596; 3,937,418; 4,018,189; 4,202,510; 4,269,150; 4,328,766; 4,501,230; 4,748,937; 4,887,551; 4,964,370; 5,377,626; 5,483,926; 5,890,456; 6,148,773; 6,405,683; 6,526,918; 6,694,922; 6,792,893; 6,845,736; 2004/0237906 A1; and 2005/0103282 A1.

Turning back to FIG. 1, the handle 14 is connected to the second end 20 of the shaft 12. The handle of FIG. 1 shows only one of many handle shapes possible, and those skilled in the art will recognize that many other handle configurations are possible. In fact, other exemplary handle configurations will be disclosed below.

The grip portion 32 of handle 14 is angled away from the shaft 12 so that an angle 30 formed between the grip portion 32 and the shaft 12 is greater than zero degrees. This provides a tilt to the grip portion 32 of handle 14 in a downwards direction. The grip portion 32 may also be angled such that it is tilted in an upwards direction, with an angle greater than zero degrees. Handle 14 may be formed from any of a number of materials, such as plastic. The grip 32 may be formed of the same material as the handle 14. Also, in order to increase comfort, reduce slippage, or absorb perspiration, the grip 32 may be soft, may be ergonomically shaped, include or be formed of rubber, neoprene, or other like material, or be formed of or include an elastomeric coating such as santoprene, kraton, pebax, or other like material.

Actuators 26 and 28 are positioned proximal to the grip 32 and are generally arranged so as to allow the user to operate both actuators with one hand, while holding the handle 14. There may be a fewer or a greater number of actuators than what is shown, depending on the specific configuration of the retractable leash assembly 24.

The leash 16 is connected at a first leash end 38 to the retractable leash assembly 24 and extends through the handle through opening 36. The opening 36 may also include a ring formed of a lubricious material for reducing friction between the leash 16 and handle 14 as the leash 16 passes in and out of the handle 14. The leash 16 includes a connector 42 connected to the free leash end 40. When fully extended, the total length of the leash is several feet. When retracted, only a small fraction of the total length extends outwardly from the handle 14, the majority of leash being stored in the handle 14 by the retractable leash assembly 24. For example, in one embodiment, leash extends from around one foot in its retracted position to around sixteen feet in its fully extended position.

A leash is sometimes also referred to as a “lead” or “leash cord”. The leash may be formed of any of a number of materials common to animal leashes, such as metal or plastic cable, nylon, cotton, hemp, fleece, leather and the like. The leash may also be formed of or include a webbing or webbing strip. It is common to use a nylon webbing 44 connected via a transitional connector 46 to a nylon cord having a circular cross-section. The nylon cord with circular cross section permits efficient storage of the leash 16 when in a fully retracted position, and is resistant to wear. The transitional connector 46 connects the cord to the webbing and is larger than the opening 36, thereby preventing the leash from being retracted fully into, and being lost within the handle 14. Other leashes are possible, for example: a leash comprised of a cord having a substantially circular cross-section without a webbing and transitional connector, where the connector 42 prevents full retraction of the leash 16; or a leash comprised fully of a substantially flat webbing. The leash may also include an elastic portion for absorbing any jerks to the leash.

The connector 42 is illustrated as a swivel-hook, but may comprise any of a number of connectors. Swivel-hooks, and their variants, are easily attached to a dog collar, harness, halter, head-collar, muzzle, and the like. Other types of connectors 42 may include buckles, eyelets, rings, clips, plastic or metal fasteners, and the like.

As discussed, the umbrella 11 includes a canopy 10 and a shaft 12. Umbrellas are well understood in the art and nearly all umbrellas comprise a canopy (also referred to as a shade), a shaft, and ribs (not shown) connected to the shaft sometimes by a movable collar (not shown), depending on whether the canopy is collapsible. Any number of well-known designs for the canopy 10 and shaft 12 may be used with the present invention. For example canopy 10 may be collapsible; the shaft may comprise a two section shaft, shown as sections 12a and 12b in FIG. 1, so the shaft can be collapsed with the canopy, allowing for more compact storage; the umbrella may have an automatic push-button open feature so a user can open the umbrella and extend the shaft and canopy with the push of a button, shown as button 48 in FIG. 1; the canopy may have a two-tiered design or comprise a wind vent for resisting gusts of wind; the canopy may have a shape other than substantially circular when it is open; the canopy may be coated with various materials such as Teflon to resist wind and dirt; and the canopy may be made of various materials such as cotton, plastic, nylon, or silk.

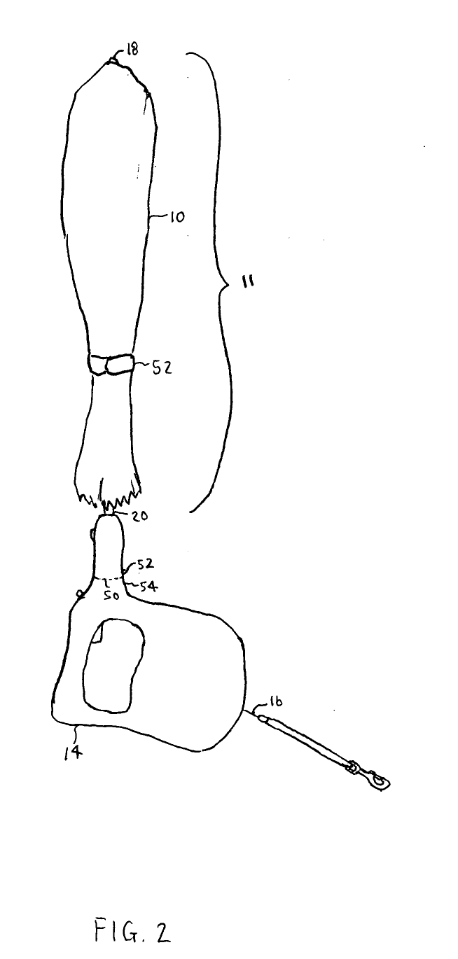

Turning now to FIG. 2, a side view of the umbrella and leash apparatus of FIG. 1 is shown with the umbrella 11 in a collapsed and stored position. The canopy 10 collapses, folds over and wraps around the shaft 12, and is secured with strap 52.

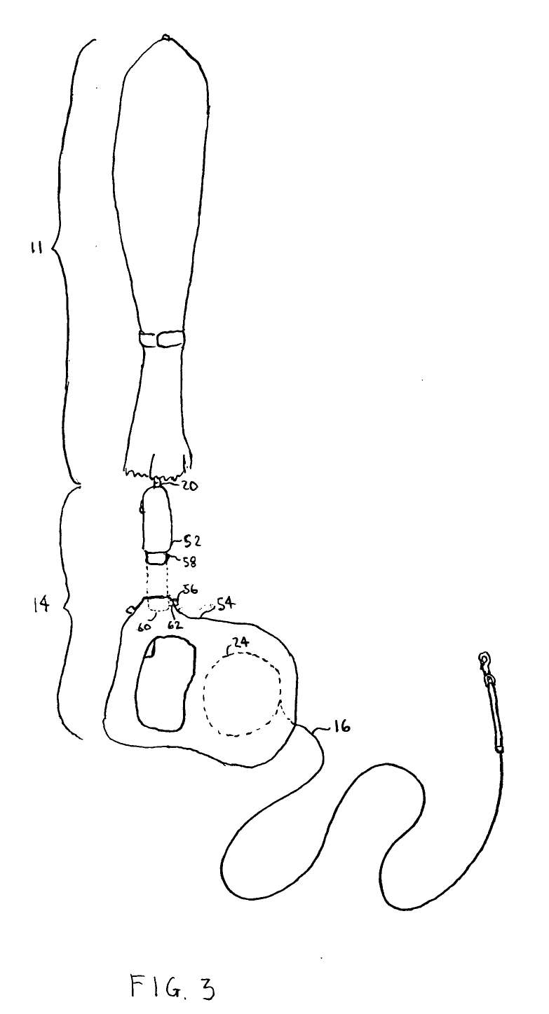

With reference to FIGS. 1 and 3, the handle 14 may optionally comprise two separatable portions, a top handle 52, and a bottom handle 54. The top handle 52 and bottom handle 54 connect and separate at interface 50.

FIG. 3 shows the umbrella and leash with the handle 14 separated. As can be appreciated, when the top handle 52 is separated from the bottom handle 54, the umbrella 11 and the leash 16 can be used separately from one another. The bottom handle 54, as described in detail above, comprises the retractable leash assembly 24. The leash 16 (shown here as partially extended) is connected to the leash assembly 24 and extends from the bottom handle 54. The top handle 52 is connected to the umbrella 11 at second shaft end 20 and provides a grip for the user to carry the umbrella. The top handle 52 may comprise any of a number of materials and configurations as described above with reference to handle grip 32.

The top handle 52 is detachably connected to the bottom handle 54, and is seated in opening 60 of the bottom handle 54. The handles 52 and 54 lock into place when seated together, secured by stop 58 which is outwardly spring-biased and engages with opening 62. To release the top handle 52 from the bottom handle 54, button 56 is depressed which forces stop 58 out of opening 62, thus allowing the handles to separate. The stop 58 and button 56 provide and audible “click” when handles 52 and 54 are locked into place. Those skilled in the art will appreciate that there are numerous other mechanisms that may be employed for connecting and detaching the top handle 52 from the bottom handle 54. In one embodiment, the top handle 52 and the bottom handle 54 are detachably and rotatably attached, so that the bottom handle 54 is operative to rotate independent of the top handle 52 while remaining connected together.

FIG. 4 shows another embodiment of a two piece detachable handle 14. The handle 14 comprises a top handle 52 and a bottom handle 54. The top handle 52 is connected to the shaft 12 at shaft second end 20. The top handle 52 comprises grip 68. The bottom handle 52 comprises actuators 26 and 28. The bottom handle also comprises a compartment 64, or hollow storage area, for storing articles such as keys, dog biscuits, disposable bags, and the like. The leash 16 exits from the bottom handle 54 through opening 36. The leash 16 includes a swivel-hook 42 connected to the free end 40 of the leash 16. As discussed above, in another embodiment, the bottom handle 52 could be angled away from the shaft 12

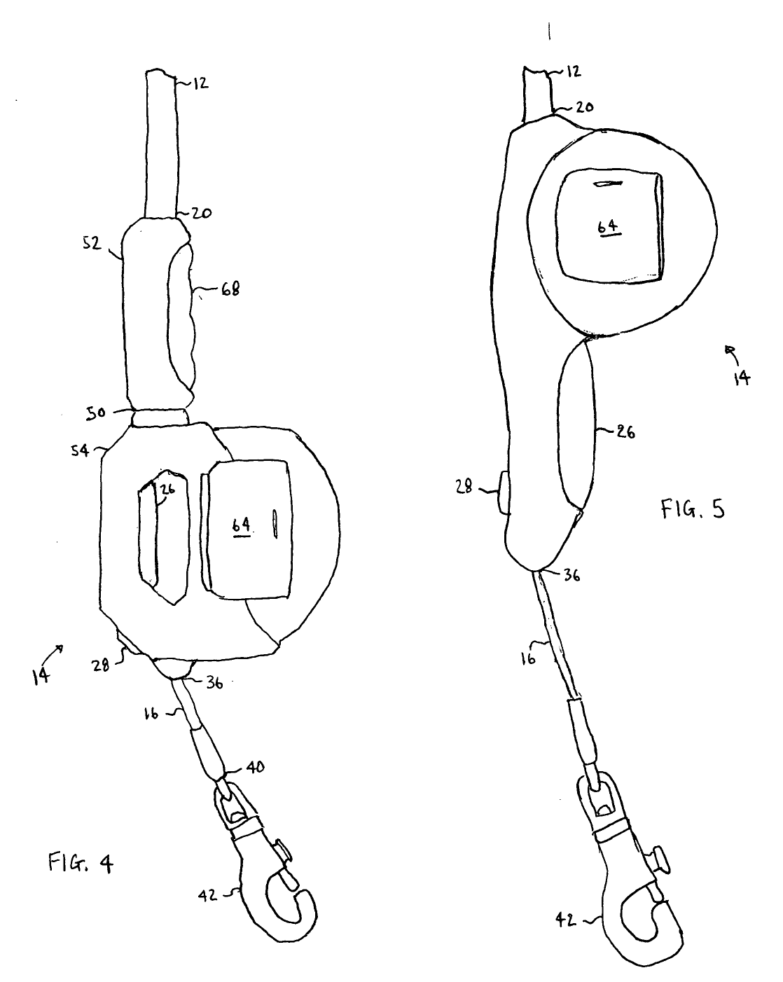

FIG. 5 shows another exemplary handle 14. Here, handle 14 is one-piece and non-detachable, that is, it is permanently connected to the shaft 12 at shaft second end 20. The handle 14 includes a compartment 64. While the handle 14 is shown in-line with the shaft 12 in FIG. 5, in an alternative embodiment the handle 14 is angled away from the shaft 12.

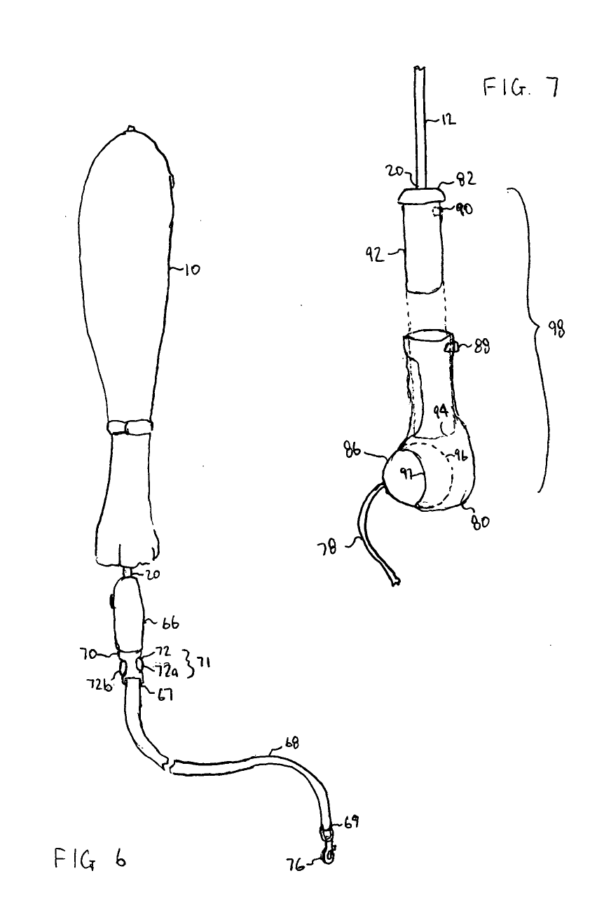

FIG. 6 shows an umbrella and leash apparatus with a fixed length, non-retractable leash. The umbrella canopy 10 is shown in a collapsed and stored position. The handle 66 is connected to second shaft end 20. A fixed-length leash 68 is attached to the handle by way of a buckle 71. The handle comprises a female buckle portion 70. A male buckle portion 72 is connected to the first leash end 67. Female buckle portion 70 and male buckle portion 72 mate to connect the leash 68 to the handle 66. The leash 68 is detachable from the handle 66 by depressing tabs 72a and 72b of male buckle portion 72. The leash 68 includes a connector 76 connected to the free-end 69 of the leash 68. The leash is shown as a webbing strip but may be comprised of any suitable material. The leash is of fixed length and is shown broken for illustrative purposes only. In another embodiment the leash 68 is permanently affixed to the handle 66, that is, buckle 71 is not present.

FIG. 7 shows a handle of an umbrella and leash apparatus with the leash attached to the handle by way of a ball-and-socket joint. The handle 98 comprises a top handle 92 and a bottom handle 80. The top handle 92 is connected to the shaft 12 at second shaft end 20. The top handle 92 is shown detached from the bottom handle 80, but the two handles attach by sliding top handle 92 into opening 94 of the bottom handle 80. The handles 92 and 80 lock together when spring-biased lock button 88 engages with opening 90 of the top handle 92. The handles 92 and 80 are detached by depressing lock button 88. Other mating mechanisms are possible and will be evident to those skilled in the art. It is also noted that a single non-detachable handle may be made.

Examining the bottom handle 80, the handle comprises a spherical socket 96 providing an opening 97 that has an opening diameter that is slightly smaller than the diameter of sphere defined by the socket 96. A ball 86, having a spherical shape and a diameter slightly less than the socket diameter of the socket 96, but greater than the opening diameter of the opening is disposed within the socket 96. A leash 78 is connected to the ball 86. Because of the relative sizes of the socket 96, the socket opening 97, and the ball 86, the ball 86 is secured within the socket 96 while being able to freely rotate within the confines of the opening. In one embodiment, the socket opening 97 is sufficiently small to secure the ball 86, while being sufficiently large to allow the ball 86 to be removed. That is, by pulling outwardly on the leash 78, pressure is exerted on the peripheral edge of the socket opening 97, the pressure causing the peripheral edge to intermittently deform thereby temporarily enlarging the opening 97 a sufficient amount to remove the ball 86. Conversely, the ball 86 may be secured back into socket 97 by pressing the ball 86 to opening 97. In one more embodiment, the ball 86 defines a hollow cavity into which a retractable leash assembly is disposed. The bottom handle 80 may be made of a material such as plastic, and the socket 96 and/or ball 86 may be coated with a lubricious material to aid in removing, inserting, and rotating the ball.

Finally, it is noted that many other variations and modifications may be made to the present invention. For example, the handles and all of the variants described herein may include a storage area; a compartment; a flashlight; a weight; a plastic bag dispenser; a hook or ring for securing items to the handle; a loop or wrist strap; a loop or fastener for securing the handle to an anchor point such as a pole or a bench; snaps and other fasteners; hook and loop fasteners. In use, the handle may be secured around a pole or other anchor point by looping the free leash end of the leash around the anchor point and through any loop, strap, or hole of or on the handle, and connecting the connector of the leash to the dog. It is also noted that in other embodiments the retractable leash assembly may extend up partially or fully into the shaft of the umbrella. And, it is lastly noted that while the present invention has been disclosed with an emphasis on dog leashes, the present invention may also be used with other animals, and may even be used to tether a child.

The foregoing detailed description has discussed only a few of the many forms that this invention can take. It is intended that the foregoing detailed description be understood as an illustration of selected forms that the invention can take and not as a definition of the invention. It is only the following claims, including all equivalents, that are intended to define the scope of this invention.

1. An umbrella and leash apparatus comprising:
an umbrella comprising a shaft and a canopy, said shaft having a first end and a second end, said canopy mounted to the first end of said shaft;
a handle connected to the second end of said shaft, said handle comprising an opening, said handle defining an interior cavity, wherein the second end of said shaft is axially connected to said handle, wherein the second end of said shaft is connected to said handle such that said umbrella shaft extends in a general upward direction from said handle; wherein the opening of said handle is positioned such that said leash extends in a general downward direction from said canopy and said umbrella shaft;
a retractable leash assembly, said retractable leash assembly mounted within the interior cavity of said handle;
at least one actuator mounted on said handle, said actuator in selective engagement with said retractable leash assembly; and
a leash, said leash having a first leash end and a free leash end, the first leash end of said leash connected to said retractable leash assembly, the free leash end extending through the opening of said handle;
wherein when said umbrella is in an extended open position said canopy extends over a user holding said handle and said canopy does not interfere with said leash;
whereby said umbrella and said leash are simultaneously usable by holding onto said handle.

2. The apparatus of claim 1 wherein said leash further comprises a connector connected to the free leash end of said leash.

3. The apparatus of claim 1 wherein said handle is angled away from said shaft at an angle of greater than zero degrees.

4. The apparatus of claim 1 wherein said handle comprises a grip.

5. The apparatus of claim 4 wherein said grip is angled away from said shaft at an angle of greater than zero degrees.

6. The apparatus of claim 1 wherein said handle comprises a top handle and a bottom handle, wherein said retractable leash assembly is mounted within said bottom handle, wherein the second end of said shaft is axially connected to said top handle wherein said top handle and said bottom handle comprise a mechanism for quickly and rigidly connecting and quickly disconnecting said top handle from said bottom handle.

7. The apparatus of claim 6 further wherein said top handle and said bottom handle are rotatably connected.

8. The apparatus of claim 6 further comprising means for connecting and releasing said top handle and said bottom handle.

9. The apparatus of claim 6 wherein said top handle and said bottom handle each define an exterior shape suitable for gripping by a user's hand.

10. The apparatus of claim 1 wherein said shaft comprises a collapsible shaft.

11. The apparatus of claim 1 wherein said canopy comprises a collapsible canopy.

12. The apparatus of claim 1 wherein said umbrella is a collapsible umbrella, wherein said handle comprises an automatic open button, wherein said umbrella extends from a collapsed position to an extended open position when said automatic open button is actuated.

13. The apparatus of claim 1 wherein said handle comprises at least one of the following: a hollow storage area, a compartment, a flashlight, a weight, a bag dispenser, a hook, a ring, a loop, a strap, a hole, a loop or strap for securing said handle around a pole, a snap, a buckle, and a hook and loop fastener.

14. An umbrella and leash apparatus comprising:
an umbrella comprising a shaft and a canopy said shaft having a first end and a second end, said canopy mounted to the first end of said shaft;
a handle connected to the second end of said shaft; and
a leash, said leash having a first leash end and a free leash end, the first leash end of said leash connected to said handle, said leash further comprising a connector connected to the free leash end of said leash.

15. The apparatus of claim 14 further comprising a buckle connected between said handle and the first leash end of said leash.

16. The apparatus of claim 14 wherein said handle comprises a retractable leash assembly, an opening, and at least one actuator mounted on said handle, wherein the first leash end of said leash is connected to said retractable leash assembly, wherein the free leash end of said leash extends through the opening of said handle, and wherein said at least one actuator is in selective engagement with said retractable leash assembly.

17. The apparatus of claim 16 wherein said retractable leash assembly extends at least partially into said handle.

18. An umbrella and leash apparatus comprising:
an umbrella comprising a shaft and a canopy, said shaft having a first end and a second end, said canopy mounted to the first end of said shaft;
a handle connected to the second end of said shaft, wherein said handle comprises a spherical socket having a socket diameter, said handle further comprising an opening to said spherical socket, said opening having an opening diameter less than the diameter of said spherical socket diameter;
a ball disposed within said socket, said ball having a spherical shape and a ball diameter less than the socket diameter of said spherical socket and greater than the opening diameter of said opening; and
a leash connected to said ball, wherein said leash further comprises a connector.

19. The apparatus of claim 18 wherein said ball further comprises a retractable leash assembly.

20. An umbrella and leash apparatus comprising:
an umbrella;
a handle attached to said umbrella, said umbrella extending in a generally upward direction from said handle;
a leash, said leash extending in a generally downward direction from said handle and said umbrella; and
leash attachment means for connecting said leash to said handle.

21. The apparatus of claim 20 further comprising means for attaching and detaching said handle from said umbrella.

22. The apparatus of claim 20 wherein said leash attachment means comprises means for detaching said leash from said handle.

23. The apparatus of claim 20 wherein said leash attachment means comprises retractable leash assembly means for extending and retracting said leash into and out of said handle.

24. The apparatus of claim 20 wherein said umbrella comprises collapsible umbrella means for collapsing and extending said umbrella.
